(19) United States
(12) Patent Application Publication
(10) Pub. No.: US 2010/0062308 A1
(43) Pub. Date: Mar. 11, 2010

(54) Membrane Electrode Assembly, Manufacturing Method Thereof and Fuel Cell

(75) Inventor: Naoko Uehara, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/556,455

(22) Filed: Sep. 9, 2009

(30) Foreign Application Priority Data
Sep. 11, 2008 (JP) 2008-233294

(51) Int. Cl. H01M 8/10; B32B 37/00

(52) U.S. Cl. 429/30; 156/299

(57) ABSTRACT

This invention provides a manufacturing method of an MEA in which electrode catalyst layers adhere sufficiently to a polymer electrolyte membrane and the fringe area of the polymer electrolyte membrane has no large waviness to cause a gas seal problem when used in a fuel cell. The method includes preparing a pair of transfer sheets each having an electrode catalyst layer on one surface of a substrate, arranging the transfer sheets in such a way that the electrode catalyst layers, respectively, face both surfaces of the polymer electrolyte membrane and the fringe area of the polymer electrolyte layer is exposed, and hot pressing the transfer sheets together with the interposed polymer electrolyte membrane, and has a feature that pressure applied during the hot pressing in a certain area is 0.5-2.0 MPa (referred to as P_{A}) and pressure applied in the other area is a value 1-3 times smaller than P_{A}.

### CROSS REFERENCE TO RELATED APPLICATION

This application is based on and claims the benefit of priority from the Japanese Patent Application number 2008-233294, filed on Sep. 11, 2008, the entire contents of which are incorporated herein by reference.

### BACKGROUND OF THE INVENTION

1. Field of the Invention

The present invention relates to a manufacturing method of a membrane electrode assembly (MEA). Furthermore, the present invention relates to a membrane electrode assembly (MEA) and a polymer electrolyte fuel cell (PEFC) using the same.

2. Description of the Related Art

Fuel cells are power generation systems which produce electric power along with heat. A fuel gas including hydrogen and an oxidant gas including oxygen reacts together on electrodes containing a catalyst so that the reverse reaction of water electrolysis takes place in a fuel cell. Fuel cells are attracting attention as a clean energy source of the future since they have advantages such as a small impact on the environment and a low level of noise production relative to conventional power generation systems. Fuel cells are divided into several types according to the employed ion conductor. A fuel cell which uses an ion-conductive polymer membrane is called a polymer electrolyte fuel cell (PEFC).

Among various fuel cells, PEFC, which can be used at around room temperature, is considered as a promising fuel cell for use in a vehicle and a household stationary power supply etc. and is being developed widely in recent years. A complex unit which has a pair of electrode catalyst layers on both sides of a polymer electrolyte and which is called a membrane electrode assembly (MEA) is arranged between a pair of separators, on which gas flow paths for supplying a fuel gas including hydrogen to one of the electrodes and an oxidant gas including oxygen to the other electrode is formed, in the PEFC. The electrode for supplying a fuel gas is called a fuel electrode, whereas the electrode for supplying an oxidant gas is called an air electrode. Each of the electrodes includes an electrode catalyst layer, which has stacked polymer electrolytes with carbon particles on which a catalyst such as a noble metal of platinum group is loaded, and a gas diffusion layer which has gas permeability and electron conductivity.

A method of making a transfer sheet in such a way that a catalyst ink which contains at least catalyst loaded particles and a polymer electrolyte is coated on a substrate and dried first, and then combining the coated catalyst ink with a polymer electrolyte membrane by hot press is known as a manufacturing method of an MEA.
<Patent document 1> JP-A-2006-309953

In the hot press, the polymer electrolyte membrane and the polymer electrolyte in the electrode catalyst layer in the transfer sheet are softened by heat and combined together by pressure. At this time if the pressure is too high, the battery performance decreases since the electrode catalyst layer is damaged, whereas if the pressure is too low, the battery performance similarly decreases since the adhesion between the polymer electrolyte membrane and the transfer sheet weakens.

In fabricating an MEA, the electrode catalyst layers are designed to have a smaller area than the interposed polymer electrolyte membrane in order to prevent an electrical leakage or short circuit therebetween. The fringe area of the polymer electrolyte in the MEA is exposed and not covered with a pair of the electrolyte catalyst layers.

In the case where an MEA is manufactured by sticking the electrode catalyst layers to both surfaces of the polymer electrolyte membrane by the hot press, rolling swells (waviness larger than a certain size) are sometimes produced on a surface of the polymer electrolyte membrane in the fringe area. This seams to occur due to a large difference between pressures applied to the transfer sheet and to the fringe area of the polymer electrolyte membrane. These rolling swells on the surface of the polymer electrolyte membrane cause a problem of gas seal failure (or insufficient gas seal) when the MEAs are stacked in a fuel cell.

### SUMMARY OF THE INVENTION

The present invention aims to provide an MEA manufacturing method whereby the electrode catalyst layers adhere sufficiently to the polymer electrolyte membrane and the rolling swells are not produced on the surface of the polymer electrolyte membrane in the fringe area so that the gas seal failure (or insufficiency) when the MEAs are stacked in a fuel cell is prevented.

In order to provide such an MEA, a first aspect of the present invention is a method of manufacturing an MEA including preparing a pair of transfer sheets, each of which has an electrode catalyst layer on one surface of a substrate, arranging a polymer electrolyte membrane between the pair of transfer sheets in such a way that each of the electrode catalyst layers faces both surfaces of the polymer electrolyte membrane and at the same time a fringe area of the polymer electrolyte layer is exposed and not covered with the electrode catalyst layers so that a stacked unit is obtained, and adhering the transfer sheets in the stacked unit to the polymer electrolyte membrane interposed therebetween by hot press to make the MEA. And this aspect of the present invention has a feature that when P_{A} is defined as a pressure applied during the hot press to an area on the electrode catalyst layer in which the polymer electrolyte membrane is covered with the electrode catalyst layer and P_{B} is defined as a pressure applied during the hot press to the fringe area of the polymer electrolyte membrane, in which the polymer electrolyte membrane is exposed and is not covered with the electrode catalyst layers of the transfer sheets, P_{A} is in the range of 0.5-2.0 MPa and P_{A}/P_{B}, which is a ratio of P_{A} relative to P_{B}, is more than 1 and less than or equal to 3.

In addition, a second aspect of the present invention is the method according to the first aspect of the present invention, wherein a buffer cushion is arranged in such a way that at least one side of the stacked unit including the fringe area of the polymer electrolyte is entirely covered with the buffer cushion during the hot press.

In addition, a third aspect of the present invention is an MEA manufactured by the method according to the first aspect of the present invention.

In addition, a fourth aspect of the present invention is a fuel cell comprising the MEA according to the third aspect of the present invention, a pair of gas diffusion layers and a pair of separators, the MEA being arranged between the pair of gas diffusion layers, and the pair of gas diffusion layers, between which the MEA is interposed, being further arranged between the pair of separators.

In addition, a fifth aspect of the present invention is a method of manufacturing an MEA including preparing a pair of transfer sheets, each of which has an electrode catalyst layer on one surface of a substrate, arranging a polymer electrolyte membrane between the pair of the transfer sheets in such a way that each of the electrode catalyst layer faces both surfaces of the polymer electrolyte membrane and at the same time a fringe area of said polymer electrolyte layer is exposed and not covered with the electrode catalyst layers so that a stacked unit is obtained, and adhering the transfer sheets in the stacked unit to the polymer electrolyte membrane interposed therebetween by hot press to make the MEA. And this aspect of the present invention has a feature that a buffer cushion is arranged in such a way that at least one side of the stacked unit including the fringe area of the polymer electrolyte is entirely covered with the buffer cushion during the hot press, and when C_{C} is defined as a compression ratio (of a portion of the buffer cushion on an area in which the polymer electrolyte membrane is covered with the electrode catalyst layer) in the pressure direction during said hot press and C_{D} is defined as a compression ratio (of a portion of the buffer cushion on the fringe area, in which the polymer electrolyte membrane is not covered with the electrode catalyst layers of the transfer sheets,) in the pressure direction during the hot press, C_{C} and C_{D} satisfy a relation of 0.4≦C_{C}<C_{D}≦0.6.

In addition, a sixth aspect of the present invention is an MEA manufactured by the method according to the fifth aspect of the present invention.

In addition, a seventh aspect of the present invention is a fuel cell comprising the MEA according to the sixth aspect of the present invention, a pair of gas diffusion layers and a pair of separators, the MEA being arranged between the pair of gas diffusion layers, and the pair of gas diffusion layers, between which the MEA is interposed, being further arranged between the pair of separators.

In addition, an eighth aspect of the present invention is an MEA including a pair of electrode catalyst layers and a polymer electrolyte membrane, the polymer electrolyte membrane being arranged between the pair of electrode catalyst layers, a fringe area of the polymer electrolyte membrane being uncovered with the pair of electrode catalyst layers and exposed, and the maximum peak height Wₚ of a waviness curve, which is obtained using a profile filter with a cut-off wavelength λ_{f} of 4 mm and a cut-off wavelength λ_{c} of 0.8 mm, in a region within the fringe area of the polymer electrolyte membrane surface being less than or equal to 50 μm.

In addition, a ninth aspect of the present invention is a fuel cell comprising the MEA according to the eighth aspect of the present invention, a pair of gas diffusion layers and a pair of separators, the MEA being arranged between the pair of gas diffusion layers, and the pair of gas diffusion layers, between which the MEA is interposed, being further arranged between the pair of separators.

An MEA which has sufficient adhesion strength between the electrode catalyst layers and the polymer electrolyte membrane, and further which is free from swells on the surface of the polymer electrolyte membrane in the fringe area in which the polymer electrolyte membrane is exposed can be produced according to the manufacturing method of an MEA of the present invention. The MEA of the present invention is free from swells on the surface of the polymer electrolyte membrane in the fringe area so that it becomes possible to manufacture a fuel cell without a gas leakage failure (or insufficiency) by stacking the MEAs.

### BRIEF DESCRIPTION OF THE DRAWINGS

FIG. 1A is a diagrammatic perspective view of an MEA of the present invention. FIG. 1B is an exemplary cross sectional view of an MEA of the present invention.

FIG. 2A is an explanatory diagram of a manufacturing method of an MEA of the present invention. FIG. 2B is an explanatory diagram of a manufacturing method of an MEA of the present invention.

FIG. 3 is an explanatory diagram of a hot press in a manufacturing method of an MEA of the present invention.

FIG. 4 is an exploded exemplary diagram of a fuel cell of the present invention.

### DESCRIPTION OF REFERENCE NUMERALS AND SIGNS

1: Polymer electrolyte membrane.
2: (First) electrode catalyst layer.
3: (Second) electrode catalyst layer.
4: Gas diffusion layer.
5: Gas diffusion layer.
6: Air electrode.
7: Fuel electrode.
8: Gas flow path.
9: Cooling water path.
10: Separator.
12: Membrane electrode assembly (MEA).
S: Fringe area (of polymer electrolyte membrane).
C: Buffer cushion.
H: Hot press equipment (pressing plate).

### DETAILED DESCRIPTION OF THE INVENTION

An MEA and a fuel cell of the present invention are described below. It is noted that the present invention is not limited to the embodiment described below. It is possible to reform the present invention according to the knowledge of a skilled person in the art and such reformed derivatives of the embodiment can be also included in the present invention.

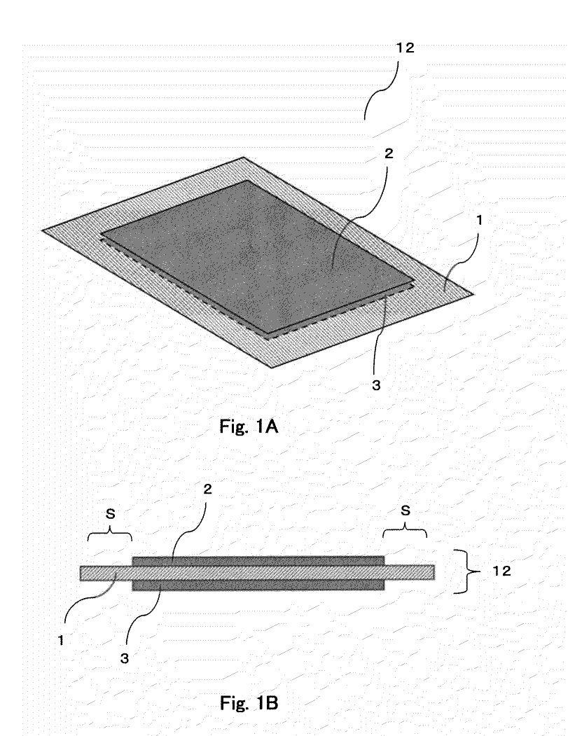

FIG. 1A shows a perspective illustration of an MEA of the present invention. In addition, FIG. 1B shows a cross sectional exemplary diagram of an MEA of the present invention. An MEA 12 of the present invention has an interposing structure where electrode catalyst layers 2 and 3 are stuck to both surfaces of a polymer electrolyte membrane 1, respectively. In addition, a polymer electrolyte membrane of the MEA 12 of the present invention has a fringe area S which is exposed and not covered with the electrode catalyst layers 2 and 3 so that an electrical leakage or a short circuit is prevented.

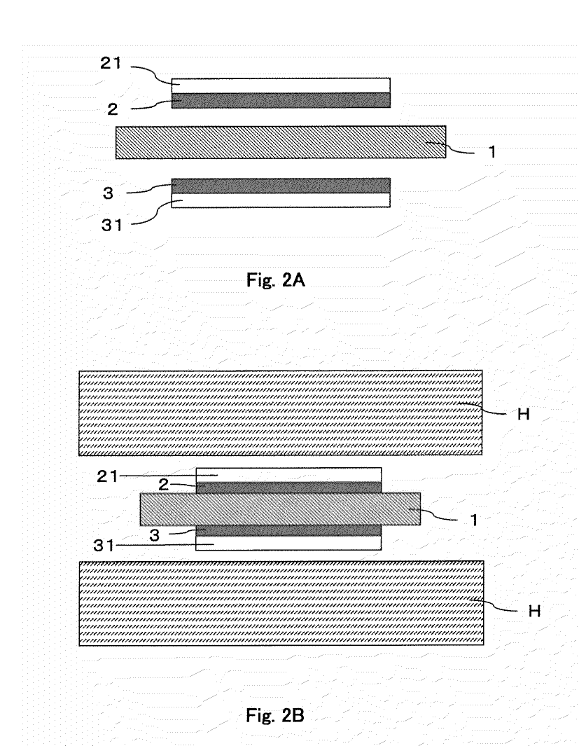

Next, a manufacturing method of an MEA of the present invention is described. FIGS. 2A and 2B show explanatory diagrams of an MEA of the present invention.

The present invention includes the following processes. The first process is preparing transfer sheets 22 and 32 which have electrode catalyst layers 2 and 3 on surfaces of substrates 21 and 31 respectively, and further, arranging the transfer sheets in such a way that the electrode catalyst layers 2 and 3 face each other with a polymer electrolyte 1 interposed therebetween and the fringe area of the polymer electrolyte 1 is kept uncovered with the electrode catalyst layers 2 and 3 (see FIG. 2A). The second process is combining a pair of transfer sheets 22 and 32 together with the interposed polymer electrolyte membrane 1 (these are referred to as a stacked unit A) by hot press (see FIG. 2B).

In the first process, a pair of transfer sheets 22 and 32 in which electrode catalyst layers 2 or 3 are formed on a substrate 21 or 31 is prepared. At this time, it is necessary that the polymer electrolyte membrane is larger in area than each of the electrode catalyst layers 2 and 3 so that its fringe area is exposed. In addition, in order to expose the fringe area of the polymer electrolyte membrane 1, the centers of the electrode catalyst layers 2 and 3 are designed to be almost in the same position as the center of the polymer electrolyte membrane 1.

In the second process, the electrode catalyst layers 2 and 3 are stuck to both surfaces of the polymer electrolyte membrane 1 by hot pressing the stacked unit A, in which the polymer electrolyte membrane 1 is arranged between a pair of transfer sheets 22 and 23.

Where P_{A} is defined as the pressure applied on an interfacial surface between the polymer electrolyte membrane 1 and the electrode catalyst layers 2, 3 during the hot press and P_{B} is defined as the pressure applied on the exposed fringe area of the polymer electrolyte membrane 1 during the hot press, it is a feature of a manufacturing method of an MEA of the present invention that P_{A} is in the range of 0.5-2.0 MPa and P_{A}/P_{B}, a ratio of A relative to P_{B}, is in the 1-3 range.

If the pressure P_{A} is less than 0.5 MPa, the battery performance decreases since the adhesion between the electrode catalyst layers and the polymer electrolyte becomes insufficient. It is also impossible to obtain sufficient battery performance if the pressure P_{A} exceeds 2.0 MPa since the electrode catalyst layers are excessively pressed.

If the value P_{A}/P_{B}, a ratio of P_{A} relative to P_{B}, is less than 1, there is a problem that rolling swells are produced in the fringe area of the polymer electrolyte membrane. In addition, in the case where the hot press is performed using a buffer cushion which covers the entire surface of the polymer electrolyte membrane, it is difficult to make the value P_{A}/P_{B} smaller than 1 because of a difference in level between the fringe area and the rest (the overlap area in which the polymer electrolyte membrane overlaps with the electrode catalyst layers). If the value P_{A}/P_{B} exceeds 3, rolling swells are similarly produced in the fringe area of the polymer electrolyte membrane.

The inventor of the present invention found that an MEA with no rolling swells on the surface of the polymer electrolyte membrane in the fringe area can be obtained by applying an additional pressure P_{B} in a predetermined range on the polymer electrolyte membrane in the fringe area when applying a predetermined pressure P_{A} on the polymer electrolyte membrane and the electrode catalyst layers sufficient to make an adhesion by hot press.

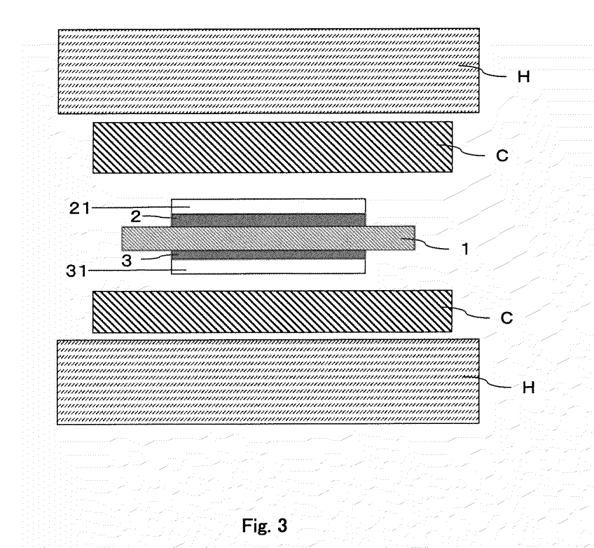

In addition, it is preferable in a manufacturing method of an MEA of the present invention that the hot press is performed using a buffer cushion sufficiently large to cover the entire surface of the polymer electrolyte membrane. FIG. 3 shows an explanatory diagram of the hot press in a manufacturing method of an MEA of the present invention.

It is preferable in a manufacturing method of an MEA of the present invention that the hot press is performed after a buffer cushion which has sufficient size to cover the entire surface of the polymer electrolyte membrane is arranged on at least one of the outermost surfaces of the stacked unit A. By arranging the buffer cushion which has sufficient size to cover the entire surface of the polymer electrolyte membrane, it becomes possible to easily apply a predetermined pressure P_{A} sufficient to adhere the electrode catalyst layers to the polymer electrolyte membrane on both the fringe area and the overlap area in which the electrode catalyst layers are overlaid on the polymer electrolyte membrane.

In addition, it is a feature of the present invention that the hot press is performed using the buffer cushion to satisfy a condition of 0.4≦C_{C}<C_{D}≦0.6, where C_{C} is a compression ratio in the press direction of the buffer cushion in the area in which the electrode catalyst layers are overlaid on the polymer electrolyte membrane, and C_{D} is the same in the fringe area in which the polymer electrolyte membrane is exposed. The compression ratios C_{C} and C_{D} are relative ratios standardized by the buffer cushion thickness before the hot press. By performing the hot press to satisfy the condition of 0.4≦C_{C}<C_{D}≦0.6, an MEA which has sufficient adhesion strength between the electrode catalyst layers and the polymer electrolyte membrane as well as no rolling swells on the surface of the polymer electrolyte membrane in the fringe area can be obtained.

If C_{C} exceeds 0.6, it is difficult to obtain sufficient adhesion strength resulting in a decrease in battery performance. If C_{C} is less than 0.4, the electrode catalyst layers are shrunk too much resulting in a similar decrease in battery performance. In addition, if C_{D} exceeds 0.6, the rolling swells are produced in the fringe area of the polymer electrolyte membrane. In the case where the hot press is performed using a buffer cushion, a relation of C_{C}<C_{D} is obtained since the buffer cushion thickness in the fringe area, in which there are no electrode catalyst layers, is naturally larger.

In addition, an MEA of the present invention has a small number of rolling swells (little waviness) and satisfies a condition that the maximum peak height Wₚ of a waviness curve which is obtained from profile filters with a cut-off wavelength λ_{f} of 4 mm and a cut-off wavelength λ_{C} of 0.8 mm is at most 50 μm on the surface of the polymer electrolyte membrane in the fringe area. If the maximum peak height of the waviness curve Wₚ exceeds 50 μm, it is impossible to make an MEA having no (or little) waviness on the surface of the polymer electrolyte membrane in the fringe area.

It is preferable that on the surface of the polymer electrolyte membrane in the fringe area, the maximum peak height Wₚ of the waviness curve obtained from profile filters with a cut-off wavelength λ_{f} 4 mm and a cut-off wavelength λ_{c} 0.8 mm is as low as possible.

A more preferable MEA of the present invention has the maximum peak height Wₚ of the waviness curve obtained from profile filters with a cut-off wavelength λ_{f} of 4 mm and a cut-off wavelength λ_{c} of 0.8 mm is at most 5 μm on the surface of the polymer electrolyte membrane in the fringe area. It is possible to make an MEA having the maximum peak height of the waviness curve Wₚ less than (or equal to) 5 μm by using a manufacturing method of an MEA of the present invention.

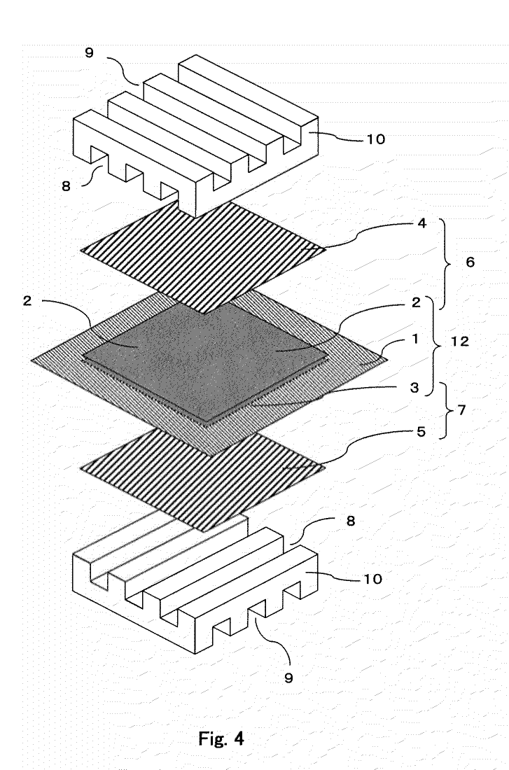

Next, a PEFC of the present invention is described. FIG. 4 shows an exploded exemplary diagram of a PEFC of the present invention.

A gas diffusion layer on the air electrode 4 and a gas diffusion layer on the cathode layer 5 are arranged facing the electrode catalyst layers 2 and 3 of the MEA 12 in a PEFC of the present invention. The air electrode 6 and the fuel electrode 7 are constituted in this way. Then a pair of separators 10 which are made of a conductive and impermeable material, and have gas flow paths 8 for transferring gas on a surface along with cooling water paths 9 on the other surface are further arranged. For example, hydrogen gas is supplied as the fuel gas from the gas flow path 8 of the separator on the fuel electrode, whereas for example, a gas containing oxygen is supplied as the oxidant gas from the gas flow path 8 of the separator on the air electrode. Then, an electromotive force can be produced by an electrode reaction between oxygen and hydrogen as the fuel gas under the presence of a catalyst.

Although a PEFC illustrated in FIG. 3 is a so-called single cell type PEFC, in which the polymer electrolyte membrane 1, the electrode catalyst layers 2 and 3, and the gas diffusion layers 4 and 5 are interposed between a pair of the separators 10, the present invention can also be applied to a PEFC having a structure of a plurality of single cells stacked via the separators 10.

An MEA and a PEFC of the present invention is further described in detail.

Since polymer electrolytes having proton conductivity can be used as the polymer electrolyte membrane of MEA and PEFC of the present invention, a certain type of fluoropolymer electrolytes and hydrocarbon polymer electrolytes can be used. For example, Nafion (a registered trademark) made by DuPont, Flemion (a registered trademark) made by Asahi Glass Co., Ltd., Aciplex (a registered trademark) made by Asahi Kasei Corp., and Gore Select (a registered trademark) made by W. L. Gore & Associates, Inc. etc. are available as the fluoropolymer electrolytes. Electrolyte membranes of sulfonated polyetherketone (PEK), sulfonated polyethersulfone (PES), sulfonated poly(ether ether sulfone) (PEES), sulfonated polysulfide and sulfonated polyphenylene etc. are available as the hydrocarbon polymer electrolytes. Above all, Nafion (a registered trademark) series materials made by DuPont are preferable.

The electrode catalyst layers formed on both surfaces of the polymer electrolyte membrane of an MEA of the present invention are formed by coating a catalyst ink on a transfer sheet to form an electrode catalyst layer on the transfer sheet, followed by hot pressing the transfer sheet having the electrode catalyst layer on both sides of the polymer electrolyte membrane. The catalyst ink contains at least a polymer electrolyte and catalyst loaded carbons.

Since proton conductive polymer electrolytes can be used as the polymer electrolyte contained in the catalyst ink, similar electrolytes to those suitable for the polymer electrolyte membrane can also be used in the catalyst ink. In other words, a certain type of fluoropolymer electrolytes and hydrocarbon polymer electrolytes can be used. For example, Nafion (a registered trademark) made by DuPont etc. are available as the fluoropolymer electrolytes. Electrolyte membranes of sulfonated polyetherketone (PEK), sulfonated polyethersulfone (PES), sulfonated poly(ether ether sulfone) (PEES), sulfonated polysulfide and sulfonated polyphenylene etc. are available as the hydrocarbon polymer electrolytes. Above all, Nafion (a registered trademark) series materials made by DuPont are preferable. Considering the adhesion between the electrode catalyst layer and the polymer electrolyte membrane, it is preferred to use the same material in the catalyst ink as that used as the polymer electrolyte membrane.

Metals of platinum group such as platinum, palladium, ruthenium, iridium, rhodium and osmium, and other metals such as iron, tin, copper, cobalt, nickel, manganese, vanadium, molybdenum, gallium and aluminum etc. as well as alloys, oxides and multiple oxides of these metals can be used as the catalyst of the present invention. In addition, the catalyst is preferred to have a particle size in the range of 0.5-20 nm in diameter because the catalyst activity weakens if the particle is too large whereas the stability decreases if the particle is too small. The particle size in the range of 1-5 nm is more preferable. Catalyst particles of any one or more of platinum, gold, palladium, rhodium, ruthenium and iridium are preferably used in the present invention since they have excellent electrode reactivity and promote efficient and stable electrode reactions so that the resultant PEFC has a high level of power generation performance.

Carbon particles are temporarily used as conductive powder on which the catalyst particles are loaded. Any type of carbon can be used as long as it has a particle shape and electrical conductivity along with chemical resistance to the catalyst. For example, carbon black, graphite, active carbon, carbon fiber, carbon nanotube and fullerene can be used. It becomes difficult to form electron conduction paths if the carbon particle size is too small, whereas gas diffusion gets worse and catalyst efficiency decreases if the carbon particle size is too large. Thus, it is preferable that the carbon size is in the range of about 10-1000 nm in diameter. In the range of 10-100 nm is more preferable.

There is no particular limitation to the solvent used as a dispersant of the catalyst ink as long as the solvent never chemically reacts with the catalyst particles and the polymer electrolyte and is able to dissolve or disperse the polymer electrolyte as something like a micro gel in a highly fluid state. It is, however, preferable in the solvent that at least one volatile organic solvent is contained although it is not necessary. Usually, alcohols such as methanol, ethanol, 1-propanol, 2-propanol, 1-butanol, 2-butanol, isobutyl alcohol, t-butyl alcohol and pentanol etc., ketone solvents such as acetone, methyl ethyl ketone, pentanone, methyl isobutyl ketone, heptanone, cyclohexanone, methyl cyclohexanone, acetonylacetone and diisobutyl ketone etc., ether solvents such as tetrahydrofuran, dioxane, diethylene glycol dimethyl ether, anisole, methoxytoluene and dibutyl ether etc., other polar solvents such as dimethylformamide, dimethylacetoamide, N-methylpyrrolidone, ethylene glycol, diethylene glycol, diacetone alcohol and 1-methoxy-2-propanol etc. are used. In addition, solvent mixtures of any combination of these can also be used.

In addition, a mixture with water is preferred to be used in the case where a lower alcohol solvent is used since lower alcohols involve a danger of ignition. Water may be included if the polymer electrolyte blends well together with water. There is no limitation to the amount of added water as long as the polymer electrolyte is not turned into a gel (gelated) nor separated from the solvent to become clouded.

The catalyst ink may include a dispersant in order to disperse catalyst loaded carbon particles. An anion surfactant, a cation surfactant, a zwitterionic surfactant and a nonionic water soluble surfactant etc. are available as the dispersant.

Specifically, for example, carboxylate type surfactants such as alkyl ether carbonates, ether carbonates, alkanoyl sarcosines, alkanoyl glutaninates, acyl glutaninates, oleic acid N-methyltaurine, potassium oleate diethanolamine salts, alkyl ether sulfate triethanolamine salts, polyoxyethylene alkyl ether sulfate triethanolamine salts, amine salts of specialty modified polyether ester acids, amine salts of higher fatty acid derivatives, amine salts of specialty modified polyester acids, amine salts of large molecular weight polyether ester acids, amine salts of specialty modified phosphate esters, amideamine salts of large molecular weight polyether ester acids, amide-amine salts of specialty aliphatic acid derivatives, alkylamine salts of higher fatty acids, amide-amine salts of large molecular weight polycarboxylic acids, sodium laurate, and sodium stearate, sodium oleate etc., sulfonate type surfactants such as dialkylsulfosuccinates, salts of 1,2-bis(alkoxycarbonyl)-1-ethanesulfonic acid, alkylsulfonates, paraffin sulfonates, alpha-olefin sulfonates, linear alkylbenzene sulfonates, alkylbenzene sulfonates, polynaphthylmethane sulfonates, naphthalenesulfonate-formaline condensates, alkylnaphthalene sulfonates, alkanoylmethyl taurides, sodium salt of lauryl sulfate ester, sodium salt of cetyl sulfate ester, sodium salt of stearyl sulfate ester, sodium salt of oleyl sulfate ester, lauryl ether sulfate ester salt, sodium alkylbenzene sulfonates, and oil-soluble alkylbenzene sulfonates etc., sulfate ester type surfactants such as alkylsulfate ester salts, alkyl sulphates, alkyl ether sulphates, polyoxyethylene alkyl ether sulfates, alkyl polyethoxy sulfates, polyglycol ether sulfates, alkyl polyoxyethylene sulfates, sulfonate oil, and highly sulfonated oil etc., phosphate ester type surfactants such as monoalkyl phosphates, dialkyl phosphates, monoalkyl phosphate esters, dialkyl phosphate esters, alkyl polyoxyethylene phosphates, alkyl ether phosphates, alkyl polyethoxy phosphates, polyoxyethylene alkyl ethers, alkylphenyl polyoxyethylene phosphate, alkylphenyl ether phosphates, alkylphenyl polyethoxy phosphates, polyoxyethylene alkylphenylether phosphates, disodium salts of higher alcohol phosphate monoester, disodium salts of higher alcohol phosphate diester, and zinc dialkyl dithiophosphate etc. can be used as the anion surfactant mentioned above.

For example, benzyldimethyl [2-{2-(p-1,1,3,3-tetramethylbutylphenoxy)ethoxy}ethyl]ammonium chloride, octadecylamine acetate, tetradecylamine acetate, octadecyltrimethylammonium chloride, beef tallow trimethylammonium chloride, dodecyltrimethylammonium chloride, palm trimethylammonium chloride, hexadecyltrimethylammonium chloride, behenyltrimethylammonium chloride, palm dimethylbenzylammonium chloride, tetradecyldimethylbenzylammonium chloride, octadecyldimethylbenzylammonium chloride, dioleyldimethylammonium chloride, 1-hydroxyethyl-2-beef tallow imidazoline quaternary salt, 2-heptadecenyl-hydroxyethyl imidazoline, stearamideethyldiethylamine acetate, stearamideethyldiethylamine hydrochloride, triethanolamine monostearate formate, alkylpyridium salts, higher alkylamine-ethylene oxide adducts, polyacrylamide amine salts, modified polyacrylamide amine salts, and perfluoroalkyl quaternary ammonium iodide etc. can be used as the cation surfactant stated above.

For example, dimethyl cocobetaine, dimethyl lauryl betaine, sodium laurylaminoethyl glycine, sodium laurylaminopropionate, stearyl dimethyl betaine, lauryl dihydroxyethyl betaine, amide betaine, imidazolinium betaine, lecithin, sodium 3-(ω-fluoroalkanoyl-N-ethylamino)-1-propane sulfonate, and N-{3-(perfluorooctanesulfoneamide)propyl}-N,N-dimethyl-N-carboxymethylene ammonium betaine etc. can be used as the zwitterionic surfactant mentioned above.

For example, coconut fatty acid diethanolamide (1:2 type), coconut fatty acid diethanolamide (1:1 type), beef tallowate diethanolamide (1:2 type), beef tallowate diethanolamide (1:1 type), oleic acid diethanolamide (1:1 type), hydroxyethyl laurylamine, polyethylene glycol laurylamine, polyethylene glycol cocoamine, polyethylene glycol stearylamine, polyethylene glycol beef tallow amine, polyethylene glycol beef tallow propylenediamine, polyethylene glycol dioleylamine, dimethyllaurylamine oxide, dimethylstearylamine oxide, dihydroxyethyllaurylamine oxide, perfluoroalkylamine oxides, polyvinylpyrrolidone, higher alcohol-ethylene oxide adducts, alkyl phenol-ethylene oxide adducts, fatty acid-ethylene oxide adducts, propylene glycol-ethylene oxide adduct, fatty acid esters of glycerin, fatty acid esters of pentaerithritol, fatty acid esters of sorbitol, fatty acid esters of sorbitan, and fatty acid esters of sugar etc. can be used as the nonionic surfactant mentioned above.

Among these surfactants above, sulfonate type surfactants such as alkylbenzene sulfonic acids, α-olefin sulfonic acids, sodium alkylbenzene sulfonates, oil soluble alkylbenzene sulfonates, and α-olefin sulfonates are preferable considering the dispersion performance of the dispersing agent and the influences of residual dispersing agent on the catalyst efficiency etc.

The catalyst ink receives dispersion treatment if necessary. It is possible to control the particles size and the catalyst ink viscosity by the dispersion treatment conditions. The dispersion treatment can be performed with various types of equipment. The dispersion treatment may include, for example, a treatment by a ball mill, a roll mill, a shear mill, or a wet mill and an ultrasonic dispersion treatment etc. In addition, it may also include a treatment by a homogenizer, in which stirring by a centrifugal force is performed.

The amount of the solid content in the catalyst ink is preferred to be in the range of 1-50 % by weight. In the case where the amount of the solid content is too large, cracks tend to easily occur on the surface of the electrode catalyst layer since the viscosity of the catalyst ink becomes too high. On the other hand, in the case where the amount of the solid content is too small, the forming rate of the catalyst layer becomes too low to retain appropriate productivity. The solid content mainly includes two components, that is, the carbon particles (catalyst loaded carbon particles) and the polymer electrolyte. The larger the amount of catalyst loaded carbon particles included is, the higher the viscosity of the ink becomes even when the total amount of the solid content is unchanged. If the amount of carbon particles decreases, the viscosity also falls accordingly. Thus, it is preferable that the ratio of the catalyst loaded carbon particles to the total solid content is adjusted within the range of 10-80% by weight. In addition, the catalyst ink viscosity at this time is preferably about 0.1-500 cP (more preferably about 5-100 cP). Moreover, the viscosity can also be controlled by an addition of a dispersing agent when dispersing the catalyst ink.

In addition, the catalyst ink may include a pore forming agent. Fine pores are created by removing this agent after the electrode catalyst is formed. Examples of the pore forming agent are materials soluble in acid, alkali or water, sublimation materials such as camphor, and materials which decompose by heat. If the pore former is soluble in warm water, it may be removed by water produced during the power generation.

Inorganic salts (soluble to acid) such as calcium carbonate, barium carbonate, magnesium carbonate, magnesium sulfate, and magnesium oxide etc., inorganic salts (soluble to alkali aqueous solution) such as alumina, silica gel, and silica sol etc., metals (soluble to acid and/or alkali) such as aluminum, zinc, tin, nickel, and iron etc., inorganic salts (soluble to water) aqueous solutions of sodium chloride, potassium chloride, ammonium chloride, sodium carbonate, sodium sulfate, and monobasic sodium phosphate etc., and water soluble organic compounds such as polyvinyl alcohol, and polyethylene glycol etc. are available as the pore forming agent soluble in acid, alkali or water. Not only a single material of these but a plurality of these together can effectively be used.

The catalyst ink is coated on the substrate so that an electrode catalyst layer is formed on the substrate.

At this time, a doctor blade method, a dipping method, a screen printing method, a roll coating method and a spray method etc. can be used as the coating method. Among these, the spray method such as, for example, a pressure spray method, an ultrasonic spray method, and an electrostatic spray method etc. has an advantage that agglutination of the catalyst loaded carbons hardly occurs when drying the coated catalyst ink so that an electrode catalyst layer has evenly distributed high density pores. After coating on the transfer sheet, the catalyst ink is dried to remove the solvent if necessary and the electrode catalyst layer is formed.

The transfer sheet which is used as the substrate is principally made of a material having good transfer properties. For example, fluororesins such as ethylene tetrafluoroethylene copolymer (ETFE), tetrafluoroethylene hexafluoroethylene copolymer (FEP), tetrafluoroethylene perfluoroalkyl vinyl ether copolymer (PFA), and polytetrafluoroethylene (PTFE) etc. can be used. In addition, polymer sheets or polymer films such as polyimide, polyethylene terephthalate (PET), polyamide (nylon), polysulfone (PSF), polyethersulfone (PES), polyphenylene sulfide (PPS), polyether ether ketone (PEEK), polyetherimide (PEI), polyarylate (PAR), and polyethylene naphthalate (PEN) etc. can be used as the transfer sheet. In the case where a polymer sheet or a polymer film is used as the transfer sheet, it is possible to peel off and remove the transfer sheet after an electrode catalyst layer is stuck to the polymer electrolyte membrane so as to make an MEA in which electrode catalyst layers are arranged on both sides of the polymer electrolyte membrane.

In addition, a gas diffusion layer can also be used as the substrate. In this case, the substrate which acts as the gas diffusion layer is not peeled off after an electrode catalyst layer is stuck to the polymer electrolyte membrane.

Materials having gas diffusion properties and electric conductivity can be used as the gas diffusion layer. Specifically, a carbon cloth, a carbon paper and a porous carbon such as unwoven carbon fabric can be used as the gas diffusion layer.

In addition, in the case where the gas diffusion layer is used as the transfer sheet, a filling (or sealing) layer may preliminarily be formed on the gas diffusion layer before the catalyst ink is coated. The filling (or sealing) layer is formed to prevent the catalyst ink from seeping into the gas diffusion layer. If the filling layer is preliminarily formed, the catalyst ink is accumulated on the filling layer and a three-phase boundary is formed even when the amount of the catalyst ink is small. Such a filling layer can be formed by dispersing carbon particles in a fluororesin solution and sintering the solution at a temperature higher than the melting point of the fluororesin. Polytetrafluoroethylene (PTFE) etc. can be used as the fluororesin.

In addition, a carbon separator and a metal separator etc. can be used as the separator of the present invention. The separator may incorporate a gas diffusion layer. In the case where the separator or the electrode catalyst layer also performs the function of the gas diffusion layer, it is unnecessary to arrange any independent gas diffusion layers. A fuel cell can be fabricated joining additional equipment such as gas supply equipment and cooling equipment etc. to an MEA having such components described above.

A commercially available hot press machine can be used in the hot press process of the present invention. In addition, a material which absorbs a shock or crumples in the hot pressing direction can be used as the buffer cushion for the hot press process of the present invention. Specifically, plates and films of cellulose, natural rubber and synthetic rubber can be used.

### Example

Examples are described below. The present invention, however, is not limited to the examples below.

### Example

### <Preparation of Transfer Sheet>

After a platinum loaded carbon catalyst (trade name: TEC10E50E, made by Tanaka Kikinzoku Kogyo K.K.) and 20% by weight of polymer electrolyte solution (registered trademark: Nafion, made by DuPont) were mixed together with a solvent mixture of water and ethanol, a dispersion treatment was performed by a planetary ball mill to prepare the catalyst ink. Then, the catalyst ink was coated on a PTFE sheet as the substrate and dried for 10 minutes in an oven at 8020 C. so that a transfer sheet in which an electrode catalyst layer was arranged on one surface of the substrate was obtained.

### <Hot Press Process>

This transfer sheet was stamped out in 5 cm×5 cm of square shapes and arranged facing both surfaces of a 8 cm×8 cm of polymer electrolyte membrane (registered trademark: Nafion 212, made by DuPont) to make a stacked unit. After cellulose plates having a 9 cm×9 cm size and 1.5 mm thickness were arranged onto both surfaces of the stacked unit respectively, a hot press process was performed at 130° C. for 10 minutes. It is noted that at this moment, the cellulose plates were arranged in such a way that the entire area in both surfaces of the stacked unit was covered with the cellulose. The pressures of the hot press were set to 3.0 MPa in the region where the transfer sheets existed (referred to as a transfer sheet region) and 1.4 MPa in the region where the transfer sheets did not exist (referred to as a polymer electrolyte membrane region). In addition, compression ratios of the cellulose plate were 0.45 in the transfer sheet region (in which the polymer electrolyte membrane contacted with the electrode catalyst layers), and 0.55 in the polymer electrolyte membrane region (in which the polymer electrolyte membrane was exposed and did not contact with the electrode catalyst layers). After the hot press was performed, the stacked unit was cooled and the PTFE substrate was peeled off and removed to obtain the MEA as is shown in FIG. 1.

### Comparative Example

### <Preparation of Transfer Sheet>

The transfer sheet was prepared in the same way as in the case of the Example described above.

### <Hot Press Process>

The stacked unit same as that in the case of the Example described above was prepared using the same transfer sheets and the same polymer electrolyte membrane. After PTFE plates having 1.5 mm thickness were arranged onto both surfaces of the stacked unit respectively, a hot press process was performed at 130° C. for 10 minutes. The pressures of the hot press were set to 20 MPa in the central transfer sheet region and 0.5 MPa or less in the surrounding polymer electrolyte membrane region. After the hot press was performed, the stacked unit was cooled and the PTFE substrate was peeled off and removed to obtain the MEA.

### <Waviness Evaluation>

Surface profiles in the fringe areas of the polymer electrolyte membranes of the MEAs obtained in Example and Comparative example were measured by a microscope laser displacement meter (MLH-50 made by Oprence Co., Ltd.). Each measurement was performed within a 40 mm long region located at a point 2.0 mm away from the edge of the electrode catalyst layer within the fringe area of the polymer electrolyte membrane. The waviness curves were obtained from the measured profile curves using a profile filter with a cut-off wavelength λ_{f} 4 mm and a cut-off wavelength λ_{C} 0.8 mm. Then, the maximum peak heights Wₚ of the waviness curves were calculated.

The maximum peak heights Wₚ of the waviness curves were 5 μm or less in the Example and 66 μm in the Comparative example. Thus, it was confirmed that the MEA in the Example had a remarkably small waviness in the fringe area of the polymer electrolyte layer.

### <Battery Performance Evaluation>

Furthermore, the MEA obtained in the Example was interposed between a pair of gas diffusion layers, a pair of separators, and a pair of titanium current collectors followed by combining together with a heater so that a PEFC was fabricated. As a result of a measurement, the voltage at a current density of 0.2 A/cm² was 0.8 V, and it was confirmed that the polymer electrolyte membrane and the electrode catalyst layers adheres together sufficiently.

### INDUSTRIAL APPLICABILITY

The MEA of the present invention has relatively few problems related to gas sealing when it is applied to a PEFC. Hence, the present invention is preferably applied to a PEFC, especially for a stationary cogeneration system and electric vehicle etc.

What is claimed is:

1. A method of manufacturing an MEA, the method comprising:
preparing a pair of transfer sheets, each of which has an electrode catalyst layer on one surface of a substrate;
arranging a polymer electrolyte membrane between said pair of said transfer sheets in such a way that each of said electrode catalyst layers faces both surfaces of said polymer electrolyte membrane, and at the same time, a fringe area of said polymer electrolyte layer is exposed and not covered with said electrode catalyst layers so that a stacked unit is obtained; and
adhering said transfer sheets in said stacked unit to said polymer electrolyte membrane interposed therebetween by hot press to make said MEA, a pressure applied during said hot press to an area on said electrode catalyst layer in which said polymer electrolyte membrane is covered with said electrode catalyst layer being P_{A}, a pressure applied during said hot press to said fringe area of said polymer electrolyte membrane, in which said polymer electrolyte membrane is exposed and is not covered with said electrode catalyst layers of said transfer sheets, being P_{B}, said P_{A} being in the range of 0.5-2.0 MPa, and P_{A}/P_{B}, which is a ratio of said P_{A} relative to said P_{B}, being more than 1 and less than or equal to 3.

2. The method according to claim 1, wherein a buffer cushion is arranged in such a way that at least one side of said stacked unit including said fringe area of said polymer electrolyte is entirely covered with said buffer cushion during said hot press.

3. An MEA manufactured by the method according to claim 1.

4. A fuel cell comprising:
the MEA according to claim 3;
a pair of gas diffusion layers; and
a pair of separators, said MEA being arranged between said pair of gas diffusion layers, and said pair of gas diffusion layers, between which said MEA is interposed, being further arranged between said pair of separators.

5. A method of manufacturing an MEA, the method comprising:
preparing a pair of transfer sheets, each of which has an electrode catalyst layer on one surface of a substrate;
arranging a polymer electrolyte membrane between said pair of said transfer sheets in such a way that each of said electrode catalyst layers faces both surfaces of said polymer electrolyte membrane, and at the same time, a fringe area of said polymer electrolyte layer is exposed and not covered with said electrode catalyst layers so that a stacked unit is obtained; and
adhering said transfer sheets in said stacked unit to said polymer electrolyte membrane interposed therebetween by a hot press to make said MEA, a buffer cushion being arranged in such a way that at least one side of said stacked unit including said fringe area of said polymer electrolyte is entirely covered with said buffer cushion during said hot press, a compression ratio of a portion of said buffer cushion on an area in which said polymer electrolyte membrane is covered with said electrode catalyst layer in the pressure direction during said hot press being C_{C}, a compression ratio of a portion of said buffer cushion on said fringe area, in which said polymer electrolyte membrane is not covered with said electrode catalyst layers of said transfer sheets, in the pressure direction during said hot press being C_{D}, and said C_{C} and said C_{D} satisfying a relation of 0.4≦C_{C}<C_{D}≦0.6.

6. An MEA manufactured by the method according to claim 5.

7. A fuel cell comprising:
the MEA according to claim 6;
a pair of gas diffusion layers; and
a pair of separators,
said MEA being arranged between said pair of gas diffusion layers, and said pair of gas diffusion layers, between which said MEA is interposed, are further arranged between said pair of separators.

8. An MEA comprising:
a pair of electrode catalyst layers; and
a polymer electrolyte membrane,
said polymer electrolyte membrane being arranged between said pair of electrode catalyst layers, a fringe area of said polymer electrolyte membrane being uncovered with said pair of electrode catalyst layers and exposed, and the maximum peak height Wₚ of a waviness curve, which is obtained using a profile filter with a cut-off wavelength λ_{f} of 4 mm and a cut-off wavelength λ_{C} of 0.8 mm, in a region within said fringe area of said polymer electrolyte membrane surface being less than or equal to 50 μm.

9. A fuel cell comprising:
the MEA according to claim 6;
a pair of gas diffusion layers; and
a pair of separators,
said MEA being arranged between said pair of gas diffusion layers, and said pair of gas diffusion layers, between which said MEA is interposed, are further arranged between said pair of separators.
